(19) United States
(12) Patent Application Publication
(10) Pub. No.: US 2023/0365442 A1
(43) Pub. Date: Nov. 16, 2023

(54) Electrified Membrane Flow-Cell Reactor For Concurrent Nitrate Reduction And Ammonia Production From Wastewater

(71) Applicants: New Jersey Institute of Technology, Newark, NJ (US); Qingdao University of Technology, Qingdao (CN)

(72) Inventors: Wen Zhang, Livingston, NJ (US); Jianan Gao, Harrison, NJ (US); Bo Jiang, Qingdao (CN)

(73) Assignees: New Jersey Institute of Technology, Newark, NJ (US); Qingdao University of Technology, Qingdao (CN)

(21) Appl. No.: 18/143,220

(22) Filed: May 4, 2023

Related U.S. Application Data
(60) Provisional application No. 63/340,193, filed on May 10, 2022.

(51) Int. Cl. C02F 1/467; C02F 1/461; C05C 3/00

(52) U.S. Cl. CPC C02F 1/4676; C02F 1/46104; C02F 1/4672; C05C 3/00; C02F 2101/163; C02F 2201/4611; C02F 2201/46115; C02F 2201/4616; C02F 2201/46185

(57) ABSTRACT

Disclosed is an electrified membrane flow-cell reactor system and method for nitrogen wastewater treatment and upcycling towards ammonia nitrogen without external acid/base consumption. This electrified membrane flow-cell reactor includes a cathodic membrane module having a gas-permeable or gas-exchange membrane and a cathodic catalytic layer, an anode, and a semi-permeable membrane between the cathodic and anodic chamber. Three chambers in the flow-cell reactor include (i) a cathode chamber for nitrate reduction and upcycling towards NH₃, (ii) a trap chamber for NH₃ capture and storage, and (iii) an anode chamber for H⁺ production and protonation of gaseous NH₃ to NH₄⁺. The cathodic membrane and anode are connected to an electric power source to provide a stable cathodic potential and enable electrode reactions. This method will continuously treat nitrate-containing wastewater and achieve simultaneous electrochemical nitrate reduction from the wastewater and ammonia recovery as ammonium salts in the trap chamber.

### CROSS REFERENCE TO RELATED APPLICATION

This application claims priority from U.S. Provisional Application No. 63/340,193 filed May 10, 2022, the disclosure of which is hereby incorporated herein by reference.

### FIELD OF USE

Disclosed is a system and method for electrochemical conversion of nitrate and/or nitrite in wastewater into ammonia that is directly recovered as ammonium salts in liquid. Specifically, the present application discloses a device and method for electrochemical conversion of nitrogen in wastewater into ammonia without addition of any external chemicals. The result is commercially useful ammonia sulfate is produced as liquid fertilizer or other industrial commodity feedstocks.

### BACKGROUND OF THE INVENTION

Nitrate that is the oxidized form of dissolved nitrogen is a source of nitrogen for plants and other vegetation to grow. Typically, nitrogen fertilizers are applied to replenish soil. However, these nitrates can enter the food chain through ground water. Nitrate contamination occurs in surface water and groundwater when nitrate is leached into the soil. Irrigation water containing nitrates from septic systems, and wastewater treatment plants are a common source of this type of contamination. Although a necessary nutrient for plants, high nitrate levels may harm other living things and affect the respiratory system, reproductive system, kidney, spleen, and thyroid. A recent report found 680 community water systems serving 21 million people in California had contaminated groundwater including nitrate.

Remediating nitrate contamination directly is difficult and expensive. Nitrate is expensive to remove from drinking water supplies, especially in public and private systems that rely on untreated groundwater and do not have the necessary water treatment infrastructure. For example, a historical 2011 report by the Pacific Institute estimated the cost of cleanup in California to be $150 million several years ago. The cost today is more than tripled for such remediation. There are some regulatory controls in place that address nitrates. However, a more comprehensive approach is needed.

Again, the accumulation of nitrate in surface water and underground aquifer can cause serious illnesses, threatening human health. Nitrate in the biosphere originates from three sources: first, acid rain deposition of nitrogen oxide derived from burning of nitrogen-containing fuels; second, bacterial decomposition of fertilizers; and third, disposal of nitrate-laden wastewater (e.g., surface runoff from agricultural land and industrial discharge). This problem will further deteriorate due to the continuously growing demand for food and water.

Adopting nitrate as a raw material to produce ammonium or ammonia is a promising pathway to remove nitrogen pollution from water while claiming useful chemicals for various industrial uses (e.g., fertilizer). The Haber-Bosch process has long been employed to produce industrial ammonium or ammonia, which consumes fossil fuels to drive the thermodynamically unfavorable reaction between nitrogen (N₂) and hydrogen (H₂) at high pressures and temperatures. However, there are currently no commercial processes or technologies for recovering the nitrogen in wastewater.

Several current technologies, such as biological nitrogen removal and chemical reduction with zero valence iron (ZVI) have been developed for nitrate degradation. Conventional biological nitrogen removal involves energy intensive nitrification and denitrification processes (~3.54 kWh·kg-N⁻¹) that converts all nitrogen species into nitrogen gas (N₂). However, biological nitrogen removal is known for the prohibitive operational cost and the produced nitrogen gas is a non-useful element.

Other previous studies mainly focus on the physical separation of ammonia (NH₃) or ammonium (NH₄⁺) from wastewater without involving the nitrate reduction. Separation processes such as air stripping, ion exchange, adsorption, membrane distillation, and osmosis-distillation membrane process often involve the use of alkaline chemicals, regenerations, and high operational costs. Among these approaches, electrochemical ammonia stripping is promising as it is close to a chemical free process and creates local alkalinity to drive NH₃ vaporization and transfer. Hydrogen evolution reaction (HER) on the cathodic surface is usually used to produce H₂ and OH⁻ that facilitates deprotonation of NH₄⁺. However, the removal or utilization of NO₃⁻/NO2⁻ and H₂ to the present investigator’s knowledge have not been explored until the present disclosure herein.

Besides those above processes or technologies, electrochemical ammonia (NH₃) stripping appears to be promising as it is close to a chemical free process and creates local alkalinity to drive NH₃ vaporization and transfer on cathode. Coupling with anodic reactions to produce acids further enables the conversion of NH₃ into ammonium sulphate (NH₄SO₄). However, nearly all electrochemical NH₃ recovery studies in literature focused on the cathodic interfacial design with a sacrificial half-reaction at the anode instead of utilizing the anodic reactions.

Clearly, external chemical addition (e.g., H₂SO₄), which increases the operation cost and disposal cost for environmental hazards. For example, strained Ru nanoclusters, CuNi alloy, organic molecular solid PTCDA modified Cu, and TiO₂₋ₓ nanotubes were reported to selectively boost the electrochemical generation of NH₃ from NO₃⁻. To capture the NH₃ gas, H₂SO₄ must be used. Moreover, the anodic reaction such as water oxidation is only employed to provide protons, while the cathodic reaction is only used to supply electrons for H₂ production or NO₃⁻ reduction without considering the ammonia stripping or recovery.

Apparently, there is an urgent need to address these drawbacks of the current technologies, and develop a smart design for efficient electrochemical conversion of nitrate/nitrite in wastewater for ammonium production without external chemical addition. Particularly, to address water pollution and resource recovery, membrane technologies play a key role as they are multifunctional, modular, scalable, resilient, and usually chemical-free. Specifically, in addition to the traditional membrane functions of solute separation via steric hindrance and charge exclusion, electrified membrane involves electrochemical oxidation and/or reduction, electrostatic adsorption and rejection, electrophoresis, and electroporation.

The electrochemical nitrate reduction reaction represents an approach that avoids the addition of reductant or hole scavenger chemicals. Electrochemical reduction technologies have been applied to treat ion-exchange brines, groundwater, municipal wastewaters, and urine. The integration of electrocatalytic processes with membrane filtration may provide new opportunities to simultaneous nitrate removal, ammonia production and recovery without acid and alkali addition.

### SUMMARY OF THE INVENTION

The presently disclosed apparatus, system, and method solves the problems of current state of the art. This electrified membrane flow-cell reactor converts NO₃⁻ to NH₄⁺ and directly generates value-added products (e.g., ammonia fertilizer) and supports nutrient recycling.

The NO₃⁻ reduction reaction on cathodic membrane domain or interface provides strong alkalinity (1.125 OH⁻ per mole-e⁻ transferred) that facilitates the conversion of NH₄⁺ to NH₃ and in turn increases the NO₃⁻ reduction efficiency as effective removal of NH₄⁺ or NH₃ via membrane stripping can reduce the blocking of active reaction sites of the cathodic membrane and reduce high overpotentials due to the product accumulation on cathode.

The electrified membrane flow-cell reactor also contains an anodic chamber to produce acids via anodic oxidation of water or hydrogen (H₂). This acidified liquid from anode chamber will be circulated back to a trap chamber on the other side of the cathode chamber to absorb ammonia and drive the membrane stripping of ammonia from the side of the cathode membrane that supports nitrate reduction reactions. The produced ammonium salts in the trap chamber will be concentrated and collected. The entire recovery and collection process involves no use of external base or acid.

One feature of this electrified membrane flow-cell reactor is the recirculation of the produced liquid containing some remaining NH₃ and hydrogen (H₂) from cathode into the anodic chamber. This liquid will shift the water oxidation (0.815 V vs. NHE) to H₂ oxidation (-0.414 V vs. NHE) on anode and significantly decreases the total cell voltage and energy consumption as water oxidation requires a higher anodic potential to proceed. The reduced anodic potential also helps avoid the potential risk of chloride oxidation, which may occur at high anode potentials (1.3 V vs. NHE).

The paired electrolysis between cathodic and anodic electrochemical half-reactions achieve multiple mass flows such as NO₃⁻ reduction, NH₃ transfer, proton production and transfer to anode, which has never been reported or optimized in other literature or technology invention.

This invention includes a novel electrified membrane flow-cell design that includes, among other things, three chambers or modules. For example, the cathodic membrane module is used for nitrate reduction reactions and also ammonia transfer or stripping across the porous cathode membrane. The anode module produces acid as mentioned above to absorb ammonia in the trap module that is connected to the cathode chamber and separated by a gas-permeable cathodic membrane. For example, the liquid pH from anode could be as low as 1.76 under the operation of the anodic current density of 50 mA cm⁻². As such, nearly 100% of the ammonia gas could be converted into ammonium salts in the trap liquid.

The construction of this three-phase interface (a gas phase such as but not limited to ammonia, an acid liquid phase, and a gas-permeable cathodic membrane phase) is the foundation design to achieve simultaneous electrochemical reduction process and membrane stripping process. This gas-permeable cathodic membrane is made of electrocatalysts with abundant active sites of NO₃⁻ reduction to NH₃ (e.g., metals, metal alloys, composite materials, nanocomposite materials, nanoparticles, and combinations thereof).

These active catalysts are immobilized via surface coating, doping or mechanical attachment onto the gas exchange hydrophobic membranes such as polytetrafluoroethylene (PTFE), polypropylene (PP), polyvinylidene fluoride (PVDF), polydimethylsiloxane (PDMS) and combinations thereof, respectively. The gas exchange membranes could be in forms of flat, hollow fiber or tubular membrane configurations.

Considering the ubiquitous existence of Cl⁻ in NO₃⁻ containing wastewater, a proton exchange membrane is used to separate the cathode and anode reaction and reduce the migration of Cl⁻ from cathode to anode, which could result in the formation of active chlorine (HOCl or OCl⁻) and oxidize NH₄⁺/NH₃ to N₂ in the anodic chamber.

The cathodic membrane module and anode are connected to electric power source includes, but not limited to direct current (DC) and alternative current (AC) power supplies, pulse current, potentiostat, electrochemical working station.

Further aspects and objectives of the invention are as follows:

(1) A method of using an electrified membrane flow-cell reactor system for wastewater treatment, comprise providing an electrified membrane flow-cell reactor module and material design including a cathode chamber, an anode chamber, and a trap chamber for optimal nitrate upcycling towards ammonia; conducting a simultaneous nitrogen containing wastewater treatment and upcycling towards ammonia (NH₃) in the cathode chamber with a special three-phase interface membrane module design and fabrication; wherein a catalytic layer and a hydrophobic gas-permeable membrane are located in the cathodic membrane module; conducting a simultaneous ammonia (NH₃) transport across the hydrophobic gas-permeable membrane and a subsequent capture of the ammonia in the trap chamber; conducting a simultaneous hydrogen ion (H⁺) production and protonation of gaseous ammonia (NH₃) to ammonium (NH₄⁺) in the trap chamber or the anode chamber; wherein wastewater is treated by removing nitrogen and upcycling towards ammonia nitrogen fertilizer without using an external acid or having base consumption.

(2) The method of using the electrified membrane flow-cell reactor system of 1, further includes utilizing the anodic chamber to produce acids to absorb ammonia into ammonium salts without the use of an external acid.

(3) The method of using the electrified membrane flow-cell reactor system of 1, further includes redirecting the fluid containing NH₃ and hydrogen gas (H₂) from the cathode chamber into the anodic chamber to shift water oxidation to hydrogen gas (H₂) oxidation and harvest the chemical energy from the hydrogen gases to decrease the total cell voltage and energy consumption of the electrified membrane flow-cell system.

(4) The method of using the electrified membrane flow-cell system of 3, further includes connecting the cathodic membrane module and the anode membrane module to at least one of a DC power source, a potentiostat, an electrochemical working station, or any combination thereof.

(5) The method of using the electrified membrane flow-cell system of 1, wherein components of the catalytic layer in the cathodic membrane module is selected from metals, metal alloys, composite materials, nanocomposite materials, nanoparticles, and combinations thereof.

(6) The method of using the electrified membrane flow-cell system of 1, wherein the catalyst layer is formed by surface coating, doping or mechanical attachment of catalysts onto the gas exchange hydrophobic membranes. The coating and doping methods include but not limited to physical coating techniques (e.g., physical vapor deposition, dip coating, spin coating, casting, filtration-evaporation, lay-by-layer assembly) and chemical coating techniques (e.g., coupling agents, sol-gel method, chemical vapor deposition, surface grafting, in situ growth). The mechanical attachment may be achieved by clipping different forms of a catalyst-containing platform onto the gas-permeable hydrophobic membrane. The catalyst-containing platform can be in forms of a sheet, a mesh, a foam, hollow fibers, porous membranes, and lamellar membranes.

(7) The electrified membrane flow-cell system of 1, wherein materials of the gas exchange membrane in the cathodic membrane module is selected from polytetrafluoroethylene (PTFE), polypropylene (PP), polyvinylidene fluoride (PVDF), polydimethylsiloxane (PDMS), and any combinations thereof.

(8) The electrified membrane flow-cell system of claim 6, wherein materials of the gas exchange membrane in cathodic membrane module has structural configurations that are flat, tubular, hollow fibers, or porous.

(9) The electrified membrane flow-cell system of claim 6, wherein a semipermeable or selective membrane is integrated into the electrified membrane flow-cell to separate the cathode chamber and the anode chamber.

(10) The electrified membrane flow-cell system of 8, wherein the semipermeable or selective membrane is selected from a group consisting of a proton exchange membrane (PEM), a cation exchange membrane, an anion exchange membrane, and any combinations thereof.

(11) The electrified membrane flow-cell system of 6, wherein the anode module has an anode and the anode is selected from a group consisting of metals, metal alloys, composite materials, nanocomposite materials, nanoparticles, and any combinations thereof.

The above aspects and advantages are all met by the present invention. The invention may further utilize variations in part or entirely for components described above to augment responses and other physical properties. In addition, the above and yet other objects and advantages of the present invention will become apparent from the hereinafter-set forth

Brief Description of the Drawings, Detailed Description of the Invention and claims appended herewith. These features and other features are described and shown in the following drawings and detailed description.

### BRIEF DESCRIPTION OF THE DRAWINGS

So that those having ordinary skill in the art will have a better understanding of how to make and use the disclosed composition and methods, reference is made to the accompanying figures wherein:

FIG. 1 is a schematic diagram of a design of an electrified membrane flow-cell reactor system;

FIG. 2 is a schematic diagram of the detailed structure of the electrified membrane flow-cell reactor shown in FIG. 1;

FIG. 3 is an illustration of the working diagram and major electrode reactions of the electrified membrane flow-cell in FIG. 1; and

FIGS. 4A, 4B and 4C are the pictures of the assembled parts of membrane modules and illustrates of operation principles using CuO as cathodic catalyst as example in FIG. 1.

### DETAILED DESCRIPTION

The present disclosure is directed to an apparatus, system, and methods comprising a novel electrified membrane flow-cell reactor that enables electrochemical conversion of nitrate/nitrite in wastewater into ammonium salts using in situ base/acid production without external chemical addition.

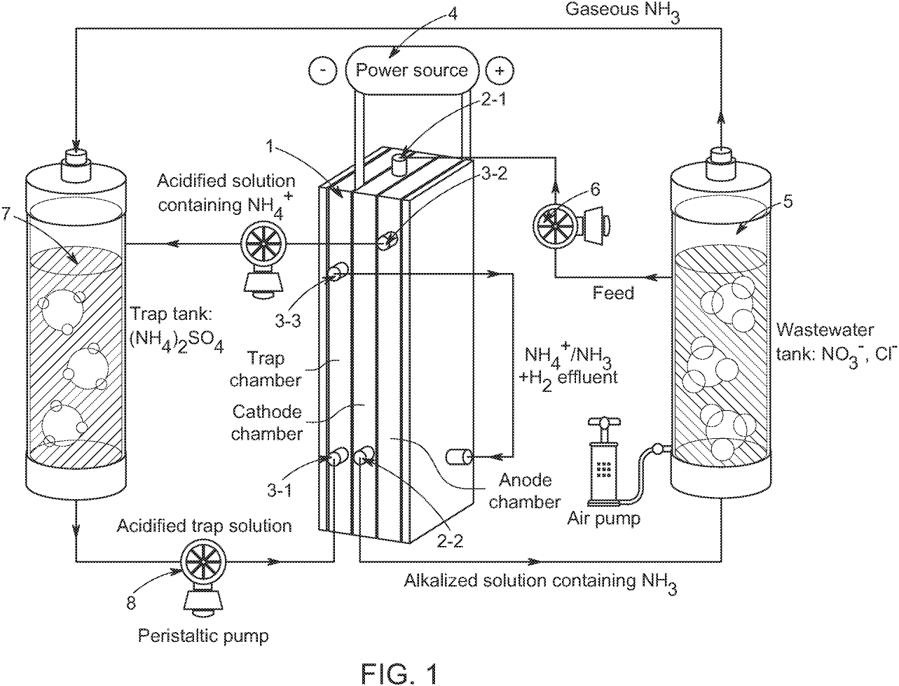

Adverting to the figures, FIG. 1 is a schematic diagram of a typical design of this electrified membrane flow-cell reaction system comprising a three-chamber flow cell 1, two influent ports 2-1 and 3-2, two effluent ports 2-2 and 3-2, and a DC electric power source 4. During the operation process of the invention, the feed nitrate wastewater in tank 5 is pumped into the influent port 2-1 by the circulating pump 6 to pass through cathodic chamber for nitrate reduction reactions and then recycled back to the nitrate wastewater tank 5. The catalytic layer or cathodic catalysts such as copper (Cu) are coated or immobilized on a gas-permeate hydrophobic membrane that separates the trap chamber and the cathodic chamber. Under a cathodic potential applied to the cathodic membrane, nitrate is electrochemically reduced to NH₃ that could immediately transfer across the cathodic membrane.

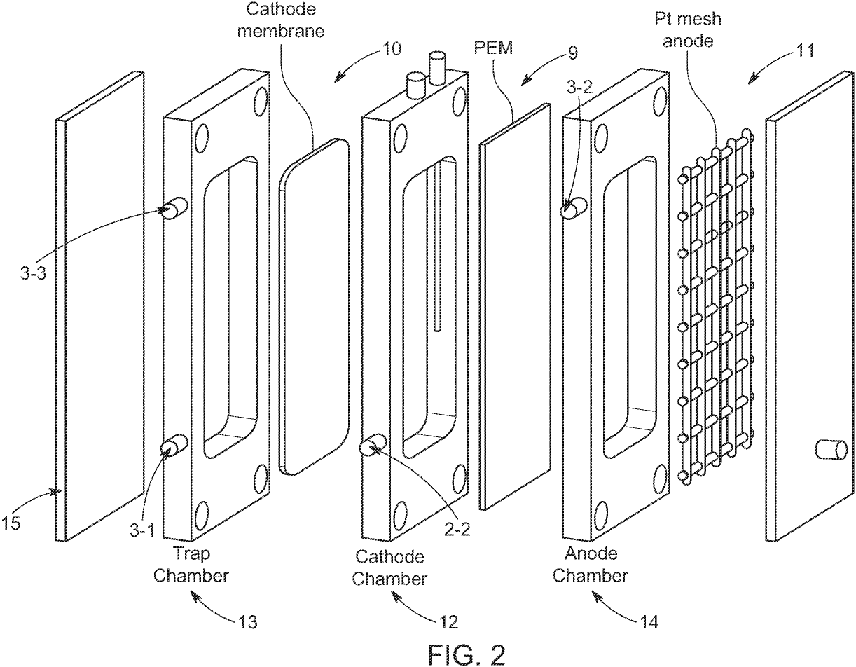

The remaining NH₃ in the alkalized solution will be circulated back to the anodic chamber and is further stripped into the trap tank filled with an acidified electrolyte solution produced from the anodic chamber. On the other hand, the electrolyte solution in the trap tank 7 is pumped into the influent port 3-1 by the circulating pump 8 to absorb the transferred NH₃, which is immediately converted to ammonium salts (e.g., NH₄SO₄ if Na₂SO₄ is used as the electrolyte) and accumulates inside the trap tank. The effluent port 3-3 circulates the electrolyte fluid into the anodic chamber for acidification due to the anodic reactions (e.g., water and/or H₂ oxidation). The acidified fluid comes outs of the effluent port 3-2 and enters the trap tank again for further use in the ammonia capture in the cathodic chamber. The electrified membrane flow-cell 1 will be described in detail in FIG. 2.

FIG. 2 is a detailed illustration of the electrified membrane flow cell structure. According to one embodiment of the invention, a proton exchange membrane (PEM) 9 with an effective reactive area of approximately 4 cm² is integrated to separate the cathode and anode chambers, preventing chlorine ions (Cl⁻) from translocating from the cathodic chamber to the anodic chamber that could result in the formation of active chlorine (HOCl or OCl⁻). These active chlorine species could oxidize NH₄⁺/NH₃ to N₂ and reduce the ammonia recovery. A cathodic membrane 10 consists of a catalytic layer and a gas exchange membrane for nitrogen pollution reduction to NH₃ and NH₃ gas transfer, respectively. Moreover, the cathodic membrane 10 is also used to separate the fluids in trap chamber and the cathodic chamber. Platinum mesh is used as the anode 11 and anchored onto an end plate (plexiglass or other insulating materials) 15 to produce H⁺ ion from water or H₂ oxidation. As said above, the produced acid in anodic chamber 14 will be used to capture the migrated NH₃ and convert to (NH₄)₂SO₄ or other ammonium salts.

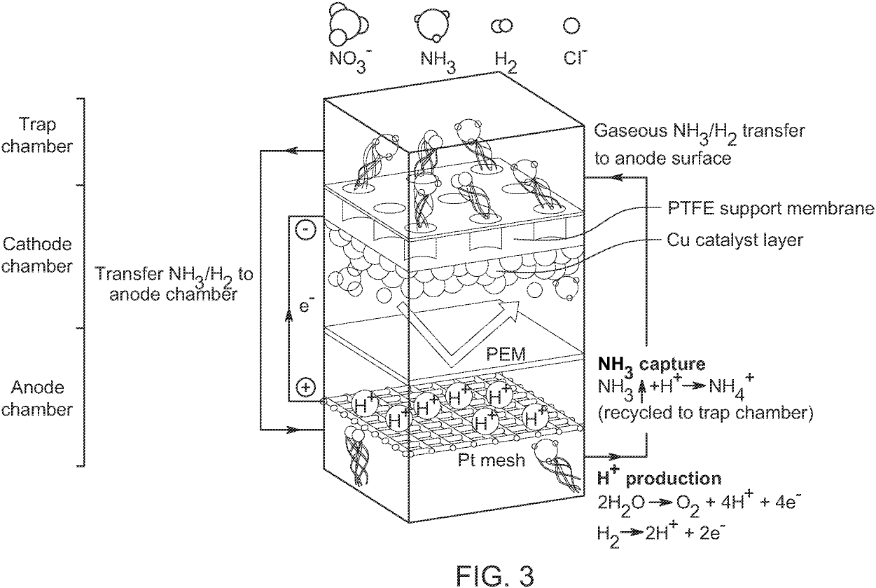

FIG. 3 illustrates the major concepts or principles of different reactions and functions achieved in different chambers or compartments.

The following examples utilize the principles set forth in this disclosure. The examples are merely given to demonstrate the principles of the present invention and do not in any way limit the scope of the invention.

### EXAMPLES

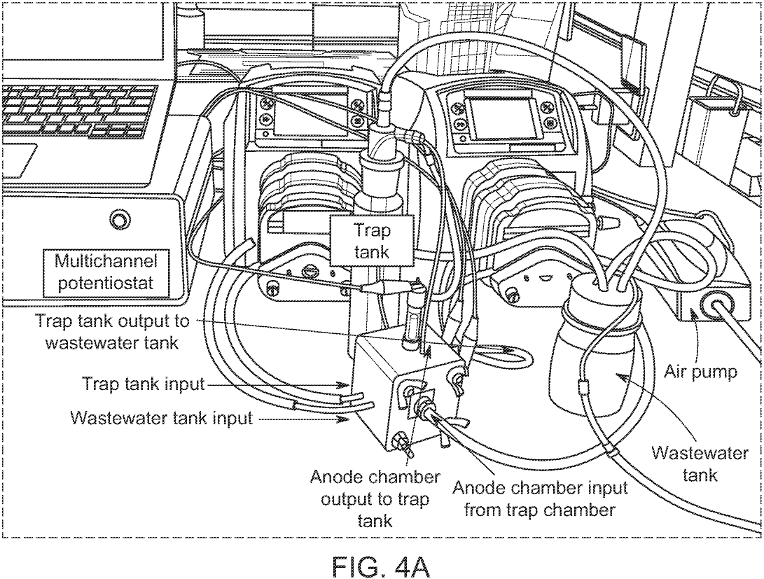

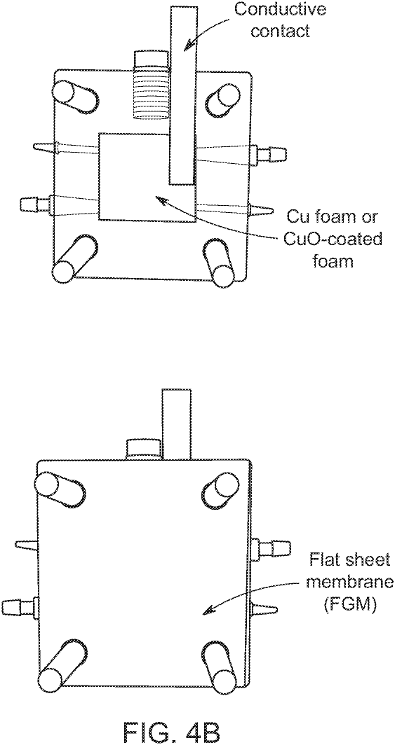

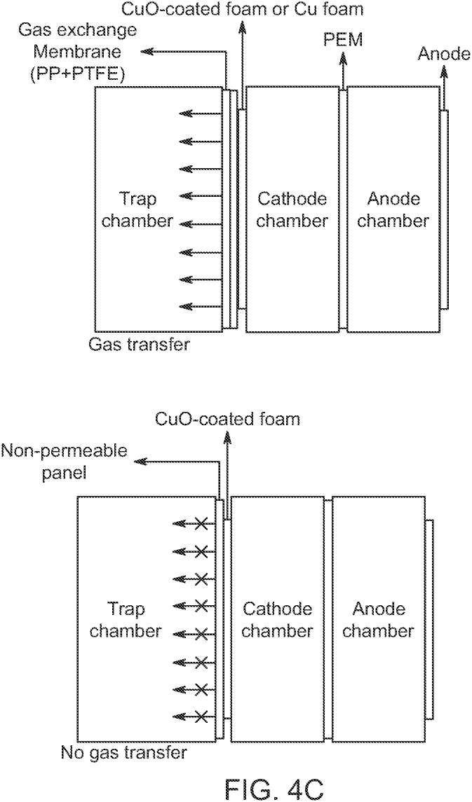

EXAMPLE 1. FIGS. 4A-4C illustrate a benchtop electrified membrane flow-cell reactor system utilizing the principles of the invention. FIG. 4A is a photograph showing a potentio-stat, a trap tank, a wastewater tank, an air pump, and other devices utilized in the system. A potentiostat is used to provide constant electrode potentials for anode and cathode. The saturated calomel electrode is connected to the CHI 1100C multichannel potentiostat (CH Instrument, USA) to measure and control the cathodic potential. FIGS. 4B-4C further illustrate the overlay of the CuO catalyst-coated foam and the gas-permeable membrane. The conductive plate (stainless steel sheet ) is used to connect the catalyst foam to the power supply.

To prepare the CuO catalyst-coated foam, a copper (Cu) foam with purity > 99.99%, a pore density of 130 ppi (pores per linear inch), and a thickness of 0.7 mm is immersed in a 3-M HCl acid for 10 min to remove the oxide layer. The Cu(OH)₂ precursor on the Cu foam (3 by 3 cm) is immersed in 25 mL 3 M NaOH solutions with another Cu foam as the counter electrode (placed about 5 cm away from each other) and applied at around 3 mA cm⁻² for 30 min. After the anodic oxidation, the form will be annealed at 300° C. for 2 h at a heating rate of 1° C.·min⁻¹ under the O₂ atmosphere to obtain the CuO layer.

Subsequently, the CuO-coated foam is clipped to a flat sheet membrane (the nominal pore size: 0.45 µm) composed of the PTFE hydrophobic surface layer and a polypropylene (PP) substrate to construct a CuO composite cathode membrane assembly. As illustrated in FIGS. 4B–4C, the PP substrate and the CuO coating layer face the trap and cathode chambers, respectively.

EXAMPLE 2. The applicants assessed the performance of nitrogen wastewater treatment and nitrogen fertilizer production using the device in FIG. 4A. The fluid was recirculated between the three chambers and the trap or feed tanks by two peristaltic pumps at 50 mL·min⁻¹. An electrolyte solution (0.5 M Na₂SO₄, pH 7) was recirculated between the trap and anode chambers, while a synthetic wastewater (150 mM NO₃⁻, 10 mM Cl⁻, 0.5 M Na₂SO₄, pH 7) was recirculated between the cathode chamber and the feed tank. The inlet temperatures at the feed were constantly maintained at 20 ± 0.5° C. throughout the entire experiment. The electrified membrane flow-cell was operated at a constant cathodic potential of -2 V vs. SCE without the control of anodic potential or the total cell potential. Finally, the nitrogen fertilizer was produced/enriched in trap chamber. The average NO₃⁻ removal rate and nitrogen fertilizer production rate were measured to be 1258±39 g-N·m⁻²·d⁻¹ and 3100±91 g-(NH₄)₂SO₄·m⁻²·d⁻¹, with a nitrate removal efficiency of 99.9% after operation time of 5 h.

EXAMPLE 3. The applicants assessed the performance of real nitrogen wastewater treatment and nitrogen fertilizer production. The real nitrate containing wastewater is made of NO₃⁻-N (436±15 mg·L⁻¹), Br⁻ (80±3 mg·L⁻¹), Cl⁻ (214±9 mg·L⁻¹), SO₄²⁻ (106728±918 mg·L⁻¹), Na⁺ (19100±523 mg·L⁻¹), K⁺ (2447±68 mg·L⁻¹), and chemical oxygen demand COD (140±4 mg·L⁻¹) with a solution pH 2.1±0.5. The NO₃⁻ removal rate and nitrogen fertilizer production rate were measured to be 436±18 g-N·m^{-2·}d⁻¹ and 1037±31 g-(NH₄)₂SO₄·m⁻²·d⁻¹, with a nitrate removal efficiency of 99.4% after operation time of 5 h.

Although the invention herein has been described with reference to particular embodiments, it is to be understood that these embodiments are merely illustrative of the principles and applications of the present invention. It is therefore to be understood that modifications may be made to the illustrative embodiments and that other arrangements may be devised without departing from the spirit and scope of the present invention as defined by the appended claims.

1. A method of wastewater treatment, comprises:
using an electrified membrane flow-cell reactor including a cathode chamber, an anode chamber, and a trap chamber for nitrate upcycling towards ammonia;
conducting a nitrogen containing wastewater treatment and upcycling towards ammonia (NH₃) in the cathode chamber with a special three-phase interface membrane module design and fabrication; wherein a catalytic layer and a hydrophobic gas-permeable membrane are located in the cathodic membrane module;
conducting an ammonia (NH₃) transport across the hydrophobic gas-permeable membrane and a subsequent capture of the ammonia in the trap chamber; and
conducting a hydrogen ion (H⁺) production and protonation of gaseous ammonia (NH₃) to ammonium (NH₄⁺) in the trap chamber or the anode chamber; wherein wastewater is treated by removing nitrogen and upcycling towards ammonia nitrogen fertilizer without using an external acid or having base consumption.

2. The method of claim 1, further includes utilizing the anodic chamber to produce acids to absorb ammonia into ammonium salts without the use of an external acid.

3. The method of claim 1, further includes redirecting the fluid containing NH₃ and hydrogen gas (H₂) from the cathode chamber into the anodic chamber to shift water oxidation to hydrogen gas (H₂) oxidation and harvest the chemical energy from the hydrogen gases to decrease the total cell voltage and energy consumption of the electrified membrane flow-cell system.

4. The method of claim 3, further includes connecting the cathodic membrane module and the anode membrane module to at least one of a power source to enable a cathodic potential and an electrode reaction, a potentiostat, an electrochemical working station, or any combination thereof.

5. The method of claim 1, wherein the catalytic layer in the cathodic membrane module has materials selected from a group of metals, metal alloys, composite materials, nanocomposite materials, nanoparticles, and combinations thereof.

6. The method of claim 1, wherein the catalyst layer is formed by surface coating, doping or mechanical attachment of catalysts onto the gas exchange hydrophobic membranes.

7. The method of claim 6, wherein the surface coating and doping methods include physical coating techniques and chemical coating techniques.

8. The method of claim 7, wherein the physical coating techniques include at least one selected from the group physical vapor deposition, dip coating, spin coating, casting, filtration-evaporation, lay-by-layer assembly, and any combination thereof.

9. The method of claim 7, wherein the chemical coating techniques include at least one selected from the group coupling agents, sol-gel method, chemical vapor deposition, surface grafting, in situ growth, and any combination thereof.

10. The method of claim 1, further includes providing a mechanical attachment to the electrified membrane flow-cell reactor module by clipping different forms of a catalyst-containing platform onto the gas-permeable hydrophobic membrane.

11. The method of claim 10, wherein the catalyst-containing platform is selected from the group a sheet, a mesh, a foam, a hollow fiber, a porous membrane, a lamellar membrane, and any combination thereof.

12. A system for wastewater treatment, comprising an electrified membrane flow-cell reactor, the electrified membrane flow-cell reactor comprises:
a cathode chamber, an anode chamber, and a trap chamber for optimal nitrate upcycling towards ammonia as compared to not using the electrified membrane flow-cell reactor.

13. The system of claim 12, wherein the cathode chamber further includes a gas exchange membrane and materials of the gas exchange membrane in the cathodic chamber is selected from a group of polytetrafluoroethylene (PTFE), polypropylene (PP), polyvinylidene fluoride (PVDF), polydimethylsiloxane (PDMS), and any combinations thereof.

14. The system of claim 13, wherein materials of the gas exchange membrane in cathodic membrane has a structural configuration selected from the group of flat, tubular, hollow fibers, porous, and any combination thereof.

15. The system of claim 12, further comprises a semi-permeable or a selective membrane integrated to separate the cathode chamber and the anode chamber.

16. The system of claim 15, wherein the semi-permeable or the selective membrane is selected from the group of a proton exchange membrane (PEM), a cation exchange membrane, an anion exchange membrane, and any combinations thereof.

17. The system of claim 12, wherein the anode chamber has an anode and the anode is selected from the group of metals, metal alloys, composite materials, nanocomposite materials, nanoparticles, and any combinations thereof.

18. A system for wastewater treatment, comprising an electrified membrane flow-cell reactor, the electrified membrane flow-cell reactor comprises:
a cathodic membrane chamber having a gas-permeable or a gas-exchange membrane and a cathodic catalytic layer, wherein the cathode chamber is for nitrate reduction and upcycling towards NH₃;
an anode chamber for H⁺ production and protonation of gaseous NH₃ to NH₄⁺;
a semi-permeable membrane or a gas-permeable hydrophobic membrane disposed between the cathodic membrane chamber and anode chamber; and
a trap chamber for NH₃ capture and storage.

19. The system of claim 18 further comprises a mechanical attachment for holding the cathodic membrane chamber, the anode chamber, and the trap chamber together, the mechanical attachment is a catalyst-containing platform clipped onto the gas-permeable hydrophobic membrane, and wherein the catalyst-containing platform is selected from the group of a sheet, a mesh, a foam, hollow fibers, a porous membrane, a lamellar membrane, and any combination thereof.

20. The system of claim 18 further comprises an electric power source connected to the cathodic membrane chamber and anode chamber to provide a stable cathodic potential and an electrode reaction.
